(19) United States
(12) Patent Application Publication
(10) Pub. No.: US 2022/0276677 A1
(43) Pub. Date: Sep. 1, 2022

(54) An Inter-Die High-Speed Expansion System And An Expansion Method Thereof

(71) Applicant: 58th Research Institute of China Electronics Technology Group Corporation, Wuxi, Jiangsu (CN)

(72) Inventors: Jinghe Wei, Wuxi, Jiangsu (CN); Letian Huang, Wuxi, Jiangsu (CN); Zongguang Yu, Wuxi, Jiangsu (CN); Tianjin Zhao, Wuxi, Jiangsu (CN); Hu Ju, Wuxi, Jiangsu (CN); Mingang Feng, Wuxi, Jiangsu (CN)

(21) Appl. No.: 17/626,825

(22) PCT Filed: Dec. 16, 2021
(86) PCT No.: PCT/CN2021/138703

§ 371 Date: Jan. 13, 2022

(30) Foreign Application Priority Data
Feb. 5, 2021 (CN) 202110167305.1

(51) Int. Cl. G06F 1/16; G06F 1/12; G06F 1/10

(52) U.S. Cl. CPC G06F 1/1656; G06F 1/12; G06F 1/10

(57) ABSTRACT

The invention relates to an inter-die high-speed expansion system and an expansion method thereof. The high speed expansion system comprises a cross-die expansion synchronizer and a direct-connection path connected with the expansion synchronizer, the cross-die expansion synchronizer is arranged on dies, the dies are connected through the cross-die expansion synchronizer and the direct-connection path, the cross-die expansion synchronizer is used for controlling data transmission, the data comprises a clock signal, a reset signal, a handshake signal and a data signal, and all the signals appear in pairs in a differential form. The system has good universality and low complexity, can realize the flexible expansion of interconnected dies, and can form a larger package level network, which lays a foundation for subsequent microsystem integration.

### TECHNICAL FIELD

The invention relates to an expansion connection of dies, in particular to an inter-die high-speed expansion system and an expansion method thereof.

### BACKGROUND ART

In a monolithic application specific integrated circuit, all components are designed and manufactured on a silicon chip using the same process. As the process size shrinks, the cost and development cycle of developing such integrated circuits have become extremely high. In this case, multi-die integration is an inevitable choice. The difficulty of multi-die integration lies in how to efficiently interconnect each die and ensure that high microsystem performance is achieved under power consumption constraints. The prior communication protocols for multi-die integration are either specialized protocols with poor versatility, or the protocols with too complex technical system that difficult to use. When the multi-die interconnection bus protocol is immature, how to define a multi-die interconnection bus protocol that meets the current integrated circuit development needs based on actual conditions and current technical level is a key issue for breaking through the new generation of integrated microsystems.

### SUMMARY OF THE INVENTION

In order to solve above technical problems, the invention provides an inter-die high-speed expansion system for multi-protocol chip cascading and expansion, which can realize cross-die interconnection of NoD (Network-on-Die) and source synchronization of cross-die interface.

The specific technical scheme:

An inter-die high-speed expansion system, comprising a cross-die expansion synchronizer and a direct-connection path connected with the expansion synchronizer, the cross-die expansion synchronizer is arranged on dies, the dies are connected through the cross-die expansion synchronizer and the direct-connection path, the cross-die expansion synchronizer is used for controlling data transmission, the data comprises a clock signal, a reset signal, a handshake signal and a data signal, and all the signals appear in pairs in a differential form.

Preferably, the cross-die expansion synchronizer comprises bidirectional LVDS, and the direct-connection path is connected to the bidirectional LVDS.

Preferably, the handshake signal is VALID/READY handshake signal.

Preferably, the data signal is DATA data signal with configurable bit width.

Preferably, the clock signal is source-synchronous clock signal.

An inter-die high-speed expansion method, comprising the following steps:

The bidirectional LVDS are adopted by inter-die for direct-connection communication, the data comprises the clock signal, the reset signal, the handshake signal and the data signal, and all the signals appear in pairs in a differential form.

Preferably, the bidirectional LVDS differentiates the clock signal, the reset signal, the handshake signal and the data signal to obtain two signals respectively, the two signals are received by a LVDS receiver, and the receiver determines the transmitted data by judging the difference between the two signals.

Preferably, the clock signal is source-synchronous clock signal, wherein associated differential clocks CPICLKb and CPICLKn at input end of the bidirectional LVDS are all derived from clocks CPOCLKb and CPOCLKn of output end of another bidirectional LVDS connected thereto.

Compared to the prior art, the invention has the following advantageous effects:

The inter-die high-speed expansion system provided by the invention is good in universality and low in complexity, flexible expansion of the interconnection dies is achieved, a larger packaging-level network is further formed, and a foundation is laid for subsequent microsystem integration. The inter-die high-speed expansion system is composed of two channels with independent clock domains, each channel has independent signals, and all signals appear in pairs in the form of differential signals, which meets the source synchronization characteristics of cross-die interfaces and high-speed communication of cross-die mutual interaction.

### BRIEF DESCRIPTION OF ACCOMPANYING DRAWINGS

FIG. 1 shows the structure of interconnected dies and structure of their interconnection.

FIG. 2 shows the structure of the inter-die high-speed expansion system;

FIG. 3 shows the structure of the direct-connection path;

FIG. 4 shows the generation and integration of differential signals.

### SPECIFIC EMBODIMENTS OF THE INVENTION

The invention is further described in combination with the accompanying drawings.

### Embodiment 1

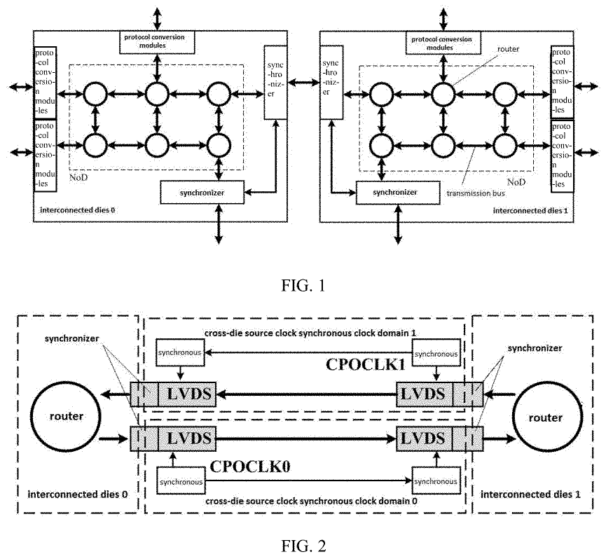

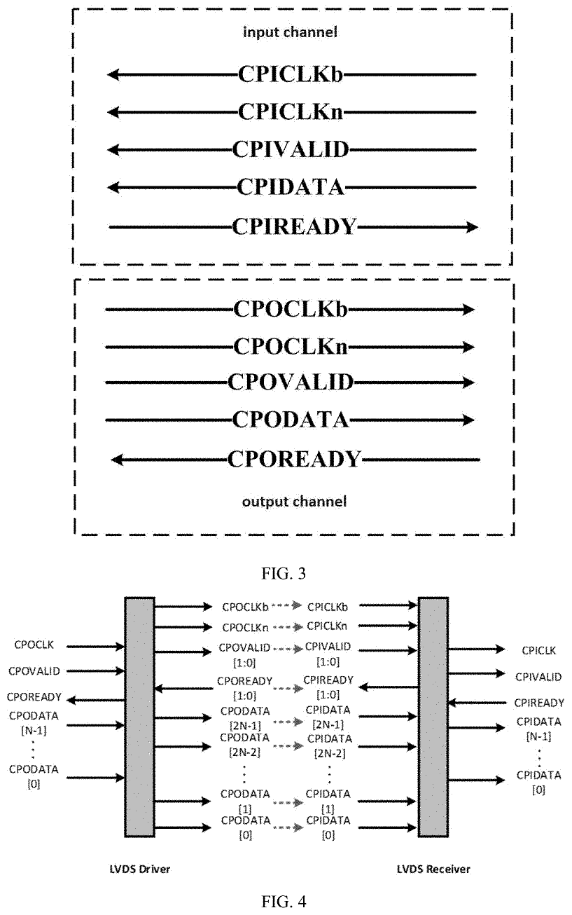

As shown in FIG. 1-4, an inter-die high-speed expansion system, comprising a cross-die expansion synchronizer and a direct-connection path connected with the expansion synchronizer, the cross-die expansion synchronizer is arranged on dies, the dies are connected through the expansion synchronizer and the direct-connection path, the cross-die expansion synchronizer is used for controlling data transmission, the data comprises a clock signal, a reset signal, a handshake signal and a data signal, and all the signals appear in pairs in a differential form.

The cross-die expansion synchronizer comprises bidirectional LVDS, and the direct-connection path is connected to the bidirectional LVDS.

The handshake signal is VALID/READY handshake signal.

The data signal is DATA data signal with configurable bit width.

The clock signal is source-synchronous clock signal.

As shown in FIG. 1, interconnected dies are an universal standard bare dies, which can easily realize data transmission, interface expansion and inter-die cascading. Inside the interconnected dies is a NoD, which consists of a router and a transmission bus. Specifically, the interconnected dies mainly comprise a protocol conversion circuit and an internal NoD, the protocol conversion circuit comprises a plurality of protocol conversion modules for providing a variety of standard mainstream protocol interfaces connected to the outside; the internal NoD comprises a transmission bus and a router, and the protocol conversion modules are respectively connected to the boundary nodes of the internal NoD for transmitting data packets from the interface. NoD is used for data routing and high-speed transmission. The protocol conversion circuit also converts the NoD protocol to the mainstream protocol for connection with other functional dies.

The cross-die expansion synchronizer is arranged on dies to realize data transmission in different clock domains inside and outside the interconnected dies, the cross-die expansion synchronizer is connected to a boundary node in NoD to form a data transmission path.

The interconnected dies are connected through the inter-die high-speed expansion system, the inter-die high-speed expansion system is also called the expansion bus, which is an inter-die expansion bus protocol for multi-protocol chips cascading and expansion, therefore, it can realize the cross-die interconnection of the NoD and the source synchronization of across-die interface.

The direct-connection path comprises an input channel and an output channel, the input channel comprises CPICLKb, CPICLKn, CPIRESETn, CPIVALID, CPIDATA and CPIREADY; the output channel comprises CPOCLKb, CPOCLKn, CPOVALID, CPODATA and CPOREADY.

The expansion bus is used for NoD cross-die interconnection, and needs to meet the source synchronization characteristics of cross-die interface, for direct-connection path, configurable bidirectional LVDS (low voltage differential signal interface) is used, the two direct-connection path of the expansion bus are composed of two channels in independent clock domains, each channel has an independent clock, reset signal, as well as VALID/READY handshake signal and DATA data signal with configurable bit width, and all signals appear in pairs in differential form.

Table 1 signal format of data in cross-die expansion synchronizer

| Signal Name | Bit Width | Direction | Description |
|---|---|---|---|
| CPICLKb | 1 | input | input channel associated |
| | | | differential clock 1 |
| CPICLKn | 1 | input | input channel associated |
| | | | differential clock 2 |
| CPIVALID | 2 | input | input channel data valid |
| CPIDATA | 2N | input | input channel data |
| CPIREADY | 2 | output | input channel data confirmation |
| CPOCLKb | 1 | output | output channel associated |
| | | | differential clock1 |
| CPOCLKn | 1 | output | output channel associated |
| | | | differential clock2 |
| CPOVALID | 2 | output | output channel data valid |
| CPODATA | 2N | output | output channel data |
| CPOREADY | 2 | input | output channel data confirmation |

The expansion bus needs to meet the high-speed communication of cross-die interconnection, the source synchronous clock is used, the associated differential clocks CPICLKb and CPICLKn of the input channel are all derived from the output port clocks CPOCLKb and CPOCLKn of the channel connected thereto; similarly, the local clock of the output channel is generated by a differentiator to generate the associated differential clocks CPOCLKb and CPOCLKn as the clock of the input channel of the port connected thereto, and the data and handshake signals also adopt the form of differential signals.

The direct-connection path of the expansion bus is composed of two channels in independent clock domains, each channel has an independent clock, reset signal, VALID, READY handshake signal, and DATA data signal with configurable bit width, and all signals appear in pairs in differential form. As shown in FIGS. 2 to 4, all signals at transmitting end are generated by LVDS to generate corresponding differential signals, and then sent to receiving end for differential signal integration.

As shown in FIGS. 2 to 4, the LVDS interface is divided into a driver and a receiver, the LVDS driver differentiates the clock signal, the reset signal, the handshake signal and the data signal to obtain two signals respectively, the two signals are received by a LVDS receiver, and the receiver determines the transmitted data by judging the difference between the two signals.

### Embodiment 1

An inter-die high-speed expansion method, comprising the following steps:

The bidirectional LVDS are adopted by inter-die for direct-connection communication, the data comprises the clock signal, the reset signal, the handshake signal and the data signal, and all the signals appear in pairs in a differential form.

The bidirectional LVDS differentiates the clock signal, the reset signal, the handshake signal and the data signal to obtain two signals respectively, the two signals are received by a LVDS receiver, and the receiver determines the transmitted data by judging the difference between the two signals.

The clock signal is source-synchronous clock signal, wherein associated differential clocks CPICLKb and CPICLKn at input end of the bidirectional LVDS are all derived from clocks CPOCLKb and CPOCLKn of output end of another bidirectional LVDS connected thereto.

The technical principle of the invention has been described above with reference to specific embodiments. These descriptions are only for explaining the principle of the invention, and cannot be construed as limiting the protection scope of the invention in any way. Based on the explanation herein, those skilled in the art can think of other specific embodiments of the invention without creative work, and these embodiments will fall within the protection scope of the claims of the invention.

1. An inter-die high-speed expansion system, comprising a cross-die expansion synchronizer and a direct-connection path connected with the expansion synchronizer, the cross-die expansion synchronizer is arranged on dies, the dies are connected through the expansion synchronizer and the direct-connection path, the cross-die expansion synchronizer is used for controlling data transmission, the data comprises a clock signal, a reset signal, a handshake signal and a data signal, and all the signals appear in pairs in a differential form.

2. The inter-die high-speed expansion system of claim 1, wherein the cross-die expansion synchronizer comprises bidirectional LVDS, and the direct-connection path is connected to the bidirectional LVDS.

3. The inter-die high-speed expansion system of claim 1, wherein the handshake signal is VALID/READY handshake signal.

4. The inter-die high-speed expansion system of claim 1, wherein the data signal is DATA data signal with configurable bit width.

5. The inter-die high-speed expansion system of claim 1, wherein the clock signal is source-synchronous clock signal.

6. An inter-die high-speed expansion method, comprising the following steps:
The bidirectional LVDS are adopted by inter-die for direct-connection communication, the data comprises the clock signal, the reset signal, the handshake signal and the data signal, and all the signals appear in pairs in a differential form.

7. The inter-die high-speed expansion method of claim 6, the bidirectional LVDS differentiates the clock signal, the reset signal, the handshake signal and the data signal to obtain two signals respectively, the two signals are received by a LVDS receiver, and the receiver determines the transmitted data by judging the difference between the two signals.

8. The inter-die high-speed expansion method of claim 6 or claim 7, the clock signal is source-synchronous clock signal, wherein associated differential clocks CPICLKb and CPICLKn at input end of the bidirectional LVDS are all derived from clocks CPOCLKb and CPOCLKn of output end of another bidirectional LVDS connected thereto.
